(19) United States
(12) Patent Application Publication
(10) Pub. No.: US 2002/0041789 A1
(43) Pub. Date: Apr. 11, 2002

(54) Binders with inside and outside pockets and methods for constructing same

(76) Inventors: Miles Conklin, St. Louis, MO (US); Michael W. Lamming, O'Fallon, MO (US); James R. Schmidt, Chesterfield, MO (US); Debra Winzen, Chesterfield, MO (US)

Correspondence Address: Kirk A. Damman, Lewis, Rice & Fingersh, L.C., Suite 2000, 500 North Broadway, St. Louis, MO, 56310, US

(21) Appl. No.: 09/954,417

(22) Filed: Sep. 17, 2001

Related U.S. Application Data
(60) Provisional application No. 60/232,766, filed on Sep. 15, 2000.

(51) Int. Cl. B42F 13/00

(52) U.S. Cl. 402/73; 402/70

(57) ABSTRACT

Herein is discussed a binder with pockets formed on both the inside and outside of the cover. The pockets may be formed by wrapping a single sheet of material around the bottom, or other, edge of the binder cover. The binder pockets may also be decorative by forming the binder of a transparent or translucent material and by forming the pockets of a translucent or opaque material so they are visible through the cover, and/or through the opposing pocket.

### CROSS REFERENCE TO RELATED U.S. APPLICATIONS

This application claims priority to U.S. Provisional Patent Application Ser. No. 60/232,766 filed Sep. 15, 2000, the entire disclosure of which is herein incorporated by reference.

### BACKGROUND OF THE INVENTION

1. Field of the Invention

This disclosure relates to the field of binders, particularly to binders with pockets for holding loose papers.

2. Description of the Related Art

The binder has become a ubiquitous sight in schools and workplaces around the country. The most common type of binder is a three-ring binder which has a three-ring element attached inside the binder cover for supporting papers which have been punched with three holes corresponding to the location of the three rings.

It is common in binders of this type to provide pockets on the inside of the cover to provide temporary storage of loose papers. However, the capacity of such pockets is limited and there is a need for additional storage space for papers which are not (or cannot be) punched and placed within the rings.

Some binders have display areas present on the outside covers. These can be on the spine or on any of the covers. These are generally made of a clear material so that identification tags can be placed on the front cover to allow identification of the binder. Because these displays are designed for use in identification of the binder (and the inserts thereto are semi-permanent), they are generally only of sufficient width to hold a single tag. Further, because the identification cover is not deigned to hold papers awaiting storage, but is designed to hold a tag for identification, it is often difficult to place and remove the tag in these displays because they enclose the entire tag to protect it and hold it securely. Still further, many of these display areas are of insufficient size or shape to hold a standard sized (8½×11) sheet of paper.

To try and deal with this storage issue, pockets which are designed to be carried on the rings have been generated but these have the problem of often being unstable and flimsy, particularly when filled with papers. These types of solutions also have the problem of taking up space in the rings, meaning that the binder is unable to hold additional papers, but can only hold papers which have not yet been punched.

### SUMMARY

Because of these and other previously unknown problems in the art, disclosed herein is a binder with pockets formed on both the inside and outside of the cover. These pockets do not enclose the entire area of the cover but are flush with the bottom edge of the binder cover and extend upward to a spaced relation with the top of the binder cover to allow for easy access to papers contained therein. The pockets may be formed by wrapping a single sheet of material around the bottom edge or other edges of the binder cover. The binder pockets also may be decorative by constructing the binder of a transparent or translucent material and by making the pockets of a translucent or opaque material so they are visible through the cover, and/or through the opposing pocket.

Disclosed herein is an embodiment of a binder comprising, a binder cover including a bottom edge, a top edge, an inside, and an outside, a sheet holding mechanism attached to and inside the binder, and a plurality of pockets, at least one pocket on the inside of the binder cover and one pocket on the outside of the binder cover, the plurality of pockets having tops spaced from the top edge of the binder cover, and bottoms flush with the bottom edge of the binder cover.

In an embodiment, the binder may comprise a three-ring binder. In another embodiment the pockets may have a wavy edge; be formed of a single sheet of material; made from at least one of a translucent material, and opaque material, and a transparent material; and/or at least one of the pockets on the inside of the binder cover may share an uncut edge with at least one pocket on the outside of the binder cover. In another embodiment, the binder cover may be made from at least one of, a translucent material, an opaque material, and a transparent material and/or may include a ring mechanism.

In another embodiment, there is disclosed, a binder comprising a binder cover including a bottom edge an inside and an outside, the binder cover being manufactured of at least one of a transparent material, and a translucent material, a sheet holding mechanism attached to and inside the binder cover, an inner pocket on the inside of the binder cover, and an outer pocket on the outside of the binder cover, wherein the inner pocket is at least partially visible from the outside of the binder through the binder cover and the outer pocket is at least partially visible from the inside of the binder cover through the binder cover.

In yet another embodiment, the inner pocket is at least partially visible from the outside of the binder through the outer pocket and the outer pocket is at least partially visible from the inside of the binder cover through the inner pocket. In yet another embodiment the binder comprises a second inner pocket and a second outer pocket, wherein the second inner pocket is at least partially visible from the outside of the binder through the binder cover and the second outer pocket is at least partially visible from the inside of the binder cover through the binder cover. In yet another embodiment, the second inner pocket is at least partially visible from the outside of the binder through the second outer pocket and the second outer pocket is at least partially visible from the inside of the binder cover through the second inner pocket.

In a still further embodiment, all the pockets are formed from a single sheet of material, the sheet holding mechanism comprises a ring mechanism, and/or the binder comprises a three-ring binder.

In a still further embodiment, there is disclosed a method of constructing a binder with inside and outside pockets, the method comprising the steps of, having a binder cover including a bottom edge, a front outer edge, a back outer edge, a top edge, an inside, and an outside, folding a sheet of material around at least one of the bottom edge, the front outer edge, and the back outer edge, attaching the sheet of material to the binder cover at a plurality of locations to form at least one pocket between the sheet of material and the binder cover on the inside of the binder cover and at least one pocket between the sheet of material and the binder cover on the outside of the binder cover, and attaching a sheet holding mechanism inside said binder.

In a still further embodiment, the sheet is translucent and/or has two wavy edges and/or the binder cover is transparent and/or translucent. In a still further embodiment at least one pocket on the inside of the binder cover is visible through the binder cover, the sheet holding mechanism comprises a ring mechanism, and/or the binder is a three-ring binder.

### BRIEF DESCRIPTION OF THE FIGURES

FIG. 1 is a perspective view of an embodiment of a ring binder including transparent covers and translucent pockets in an inside/outside configuration.

FIG. 2 shows an embodiment of a ring binder having pockets in an inside/outside configuration viewed from the inside.

FIG. 3 shows an embodiment of a ring binder having pockets in an inside/outside configuration viewed from the outside.

FIG. 4 shows a single sheet which can be used to form pockets such as those discussed in FIGS. 1, 2, and 3.

### DETAILED DESCRIPTION OF PREFERRED EMBODIMENT(S)

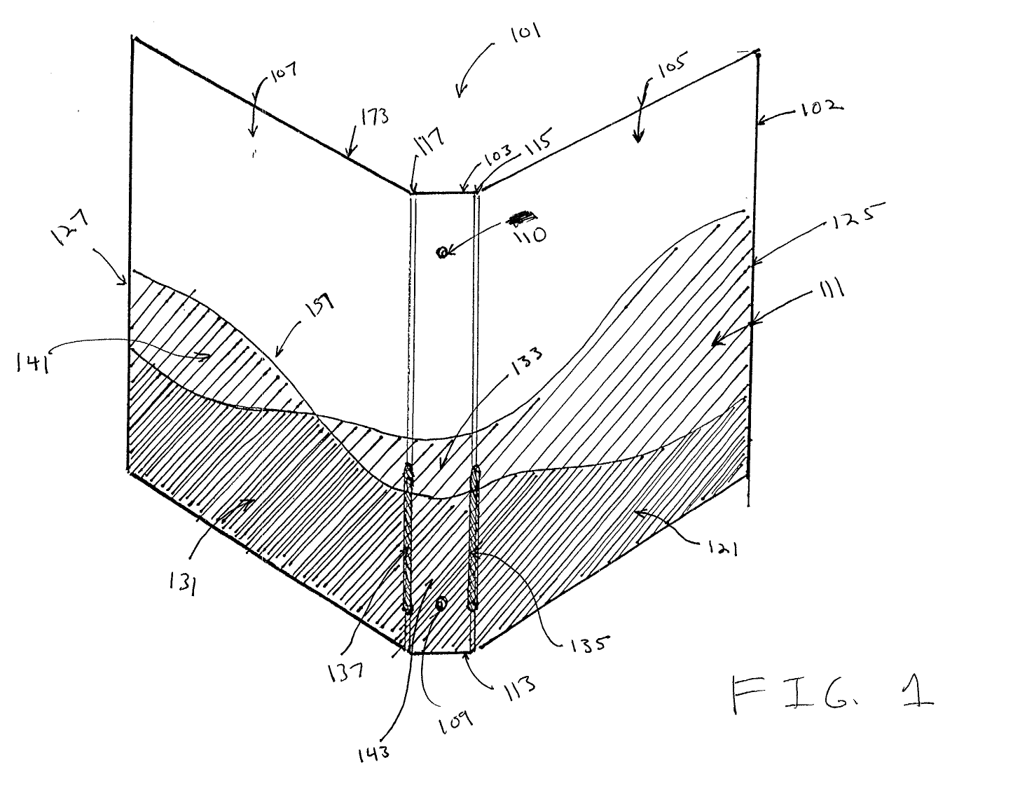

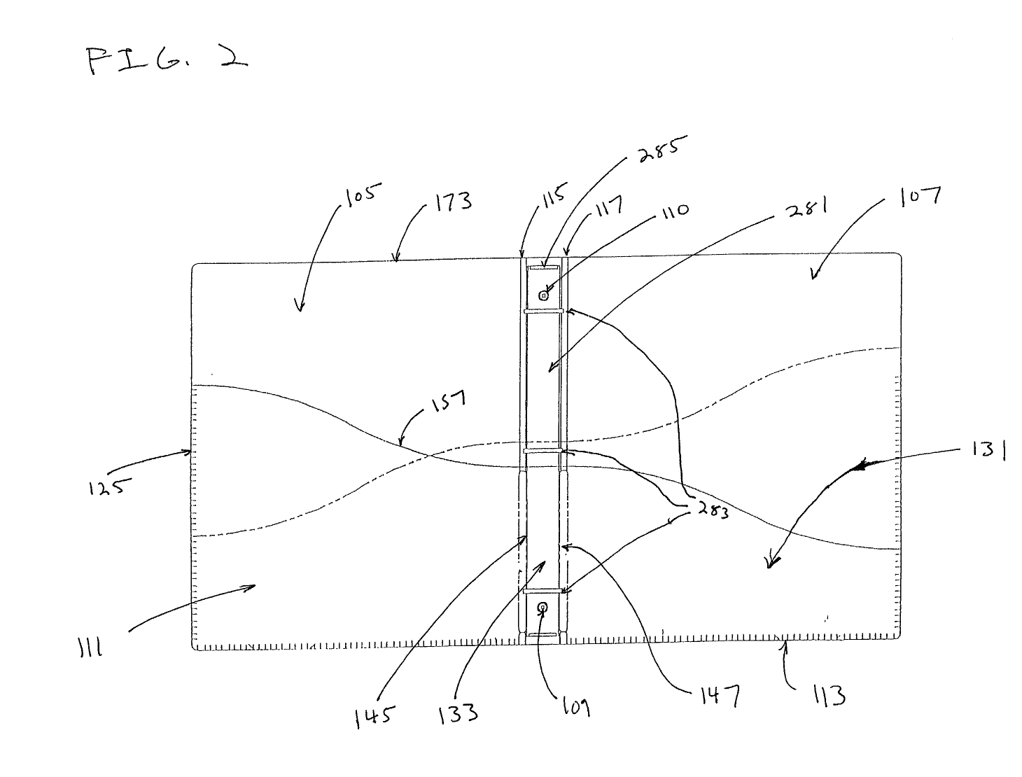

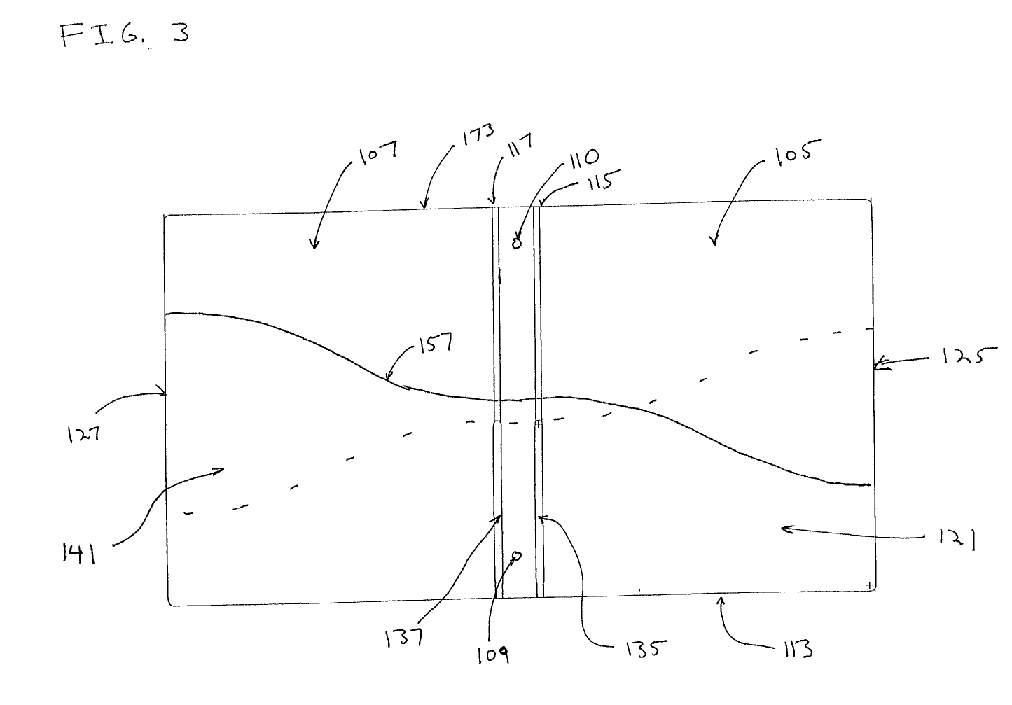

The embodiments of FIGS. 1, 2, and 3 will be discussed simultaneously since each of FIGS. 1, 2, and 3 show structure not visible in others. FIG. 1 shows a back perspective view of an embodiment of a binder (101). FIG. 2 shows an embodiment of a binder (101) as viewed from the inside and FIG. 3 shows an embodiment of a binder (101) as viewed from the outside. The binder is composed of a binder cover (102), a sheet holding mechanism (291) and a plurality of pockets (111), (121), (131), (141), (133), and (143). The binder cover (102) provides cover for the papers or materials included within the binder (101). The binder cover (102) includes a spine (103), a front cover (105), and a rear cover (107) and is generally manufactured from, but is not limited to, papers, plastics, chipboards, metals, cardboards, vinyls, or any combination of such materials. The spine (103) generally defines the width of the binder (101) and the amount of papers it can hold within it. The front cover (105) and rear cover (107) are connected to the spine by hinges (115) and (117) respectively. These hinges (115) and (117) allow for the covers to be swung way from the papers to access the papers secured in the sheet holding mechanism (291) or otherwise secured inside the binder (101). The hinges are often simply reinforced strips of the material used in the construction of the binder cover (102) and/or are score line(s) in the binder cover (102) allowing for easier bending at that point. However, in other embodiments, hinging mechanisms may be used. The sheet holding mechanism (291) is attached to the inside of the cover. The presence of this sheet holding mechanism (291) effectively defines the inside and outside of the binder (101). Although the covers can often bend in either direction freely relative to the spine (103), the covers are generally intended to cover the pages contained in the sheet holding mechanism (291). The sheet holding mechanism (291) may be any type of sheet holding mechanism but will generally comprise a ring mechanism as is depicted in FIG. 2. Ring mechanisms come in a wide variety of shapes and sizes, but generally have a similar structure. A ring holding mechanism includes a rib (281) generally constructed of a rigid material (such as metal) which is secured to the binder cover (102) through the use of rivets (109) and (110) which pierce the binder cover (102). The rib (281) has a number of rings (283), usually three although ring binders may have more or less as is understood by one of skill in the art, which extend away from the rib (281). The three-ring binder is a particular type of binder having a three-ring mechanism. The rings (283) may be circular, oval, “D” shaped or of any other shape as would be known to one of skill in the art. The rings (283) are designed to secure sheets of materials, usually papers but other objects adapted for ring storage as known to those of skill in the art, by the placement of the rings (283) through holes in the sheet to be inserted within the binder (101). The rings (283) generally separate at a point in their diameter to allow placement of objects on the rings (283) by running the structure of the rings (283) through holes in the object. The rings (283) also generally include a biasing mechanism (not shown) for holding the rings (283) in a closed and/or open position and a mechanism (285) for opening and/or closing the rings (283) to allow for hole punched papers to be added to the rings (283), or to allow for closing the rings (283) to secure of the hole-punched papers thereto. A ring mechanism is merely one of a plethora of sheet holding mechanisms (291). The invention herein can easily be adapted to use any sheet holding mechanism (291) that would be desirable in a binder as would be understood by one of skill in the art.

In FIG. 3 the sheet holding mechanism (291) is not visible. However, rivets (109) and (110) where they secure the sheet holding mechanism (291) to the binder cover (102) are visible. Although the sheet holding mechanism (291) is shown attached to the spine (103) in the FIG., many modern binders offset the sheet holding mechanism (241) from the spine (103) and place it on the back cover (107). Such a design for the binder (101) may also be used in an embodiment.

FIG. 1 further shows pockets on the bottom portion of the front cover (105), spine (103), and back cover (107). Pockets include a front outer pocket (121), a rear outer pocket (141), a spine outer pocket (143), a front inner pocket (111), a rear inner pocket (131), and a spine inner pocket (133). These pockets are formed by the placement of material (generally in the form of a thin sheet) on the inside and outside of the lower portions of the binder cover (102) and attaching that material on “edges” to the binder cover (102). To form the pockets above, there are attachment points at the outer edges (125) and (127) of the front and back covers (105) and (107), the bottom edge (113) and at the hinges (117) and (115) (specifically areas (137) and (135)) to create the outside pockets (121), (141), and (143). The inside pockets (111), (131), and (133) have attachment points at the outer edges (125) and (127) of the front and back covers (105) and (107), the bottom edge (113) and at the hinges (117) and (115) (specifically areas (145) and (147)). This provides for a three edge attachment of each pocket and allows for papers or other materials to be inserted into the top of the pocket. One of skill in the art would recognize that more or fewer attachment points may be necessary to form a pocket depending on the shape of the pocket desired. Connections of the pockets at an attachment point may occur using any method of attachment known to the art; this includes, but is not limited to, adhesives, sonic welding, thermal welding, or any combination thereof. Further, the term “attachment point” is not intended to limit the attachment to a single point but to indicate a general location where some form of attachment is desired. This may include lines, points, or other shapes.

In the preferred embodiment, the pockets extend from the bottom edge (113) of the binder cover (102) to the pocket tops (151) spaced from the top edge (173) of the binder (102) at all points. That is, the material forming the pocket does not extend from the bottom edge (113) to the top edge (173) of the binder cover (102). The pocket is shorter than the cover. The bottoms of the pockets and the binder cover (102) are flush, in the preferred embodiment, as are the outer edges of the pockets with the outer edges (125) and (127) of the binder cover (102). This design allows for easy insertion and removal of papers from the pockets, and a squared cover facilitating the placement of the binder on shelves. Generally a binder cover is sized such that the front and back covers (105) and (107) are larger than a sheet of paper of the size the binder (101) is designed to hold. The pocket, is therefore slightly smaller in width than the cover (or spine) to which it is attached to hold the paper and significantly shorter in height to allow the paper to be easily grabbed and removed from the pocket. This is as opposed to a display which extends over an entire binder cover (102). In such displays, the display has to be able to admit fingers, or other grasping devices, to retrieve the paper since the paper does not stick up beyond the top edge of the pocket. Since the paper is generally only held in place by the friction between the paper and the sides of the pocket, this can mean that either the paper is not securely held, or it is difficult to insert the grasping device making storage in these locations difficult for papers which are removed regularly.

The outer pockets (121), (141), and (143) allow for the transport of loose papers on the outside of the binder (101). Because the pockets on the outside of the binder (101) have a top distanced from the top of the cover, the pockets can be used as additional and easily accessible storage for the binder (101). Further, since these pockets are on the outside of the binder (101), they do not take up space inside the binder (101) which could be used by papers on the rings. Further, the spine pocket (143) can allow for the transport of writing utensils or other narrow objects in addition to providing a label for the binder (101). The inside pockets (111), and (131) can be used in the manner of traditional binder pockets. The inside spine pocket (133) will generally be covered by the rib (281) and be unusable, but one of skill in the art would recognize that it could be used if the sheet holding mechanism (291) was not placed on the spine, or was of a different design (such as one without a rib (281)). In a preferred embodiment, four of the pockets (the inside front (111), inside rear (131), outside front (121) and outside rear (141) are all designed to hold about 5-7 sheets of standard sized (8½″×11″) paper meaning the binder (101) can hold 20-30 sheets as opposed to the 10 or 15 of prior art designs with only two pockets.

Any of the pockets can be formed from a variety of pieces of material arranged on the front and back covers (105) and (107) in a plurality of different ways. Generally, each pocket will be formed by placing a sheet of material against the material of the binder and attaching it thereto. Like the binder cover (102), the pockets can be made of any material including, but not limited to, papers, plastics, cards, shipboards, metals, cardboards, vinyl, or any combination thereof. In an embodiment, each individual pocket may be formed from an individual sheet of material, attached at the appropriate three edges to form the pocket. In another embodiment, the inner pockets (111), (131), and (133) may all be formed from a single sheet of material, and the outer pockets (121), (141), and (143) formed from another single sheet of material with the attachment points serving to delineate the different pockets.

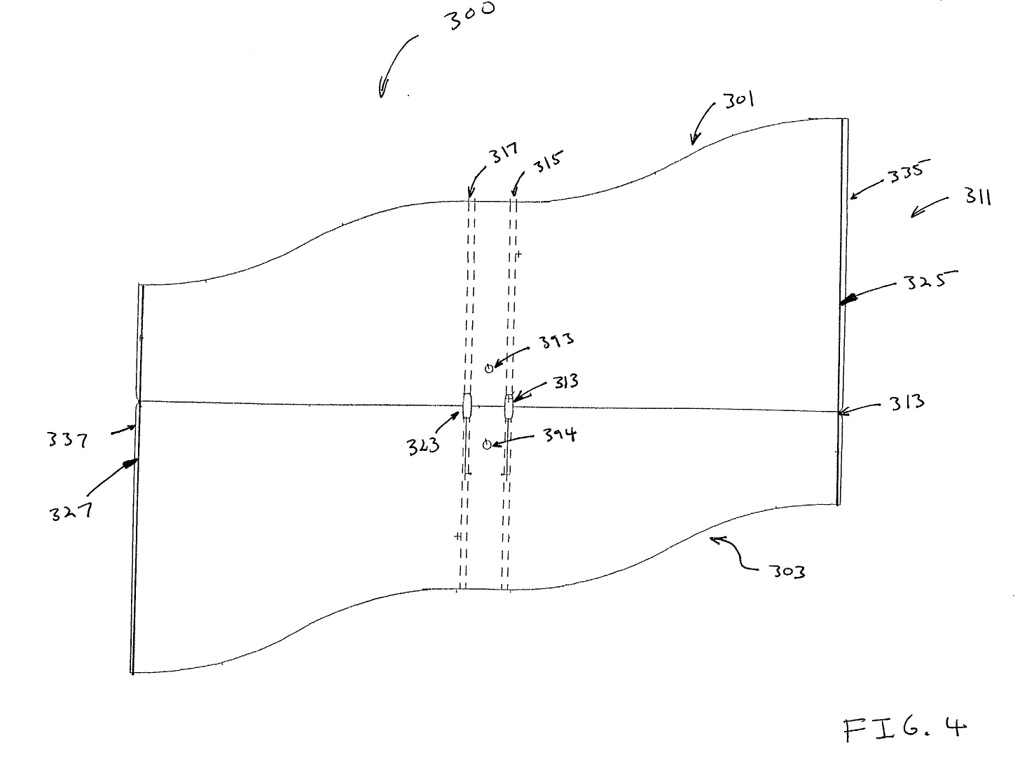

In yet another embodiment, any combination of pockets could be formed from a single sheet of material, and in a preferred embodiment, all the pockets can be formed from a single sheet of material. Forming of the pockets through the use of a single sheet of material may be carried out by forming an appropriately shaped single piece of material (such as that shown in FIG. 4) and then folding the sheet around the bottom edge (113) of the binder cover (102) and attaching it at the attachment points to form the pockets shown above. This method is particularly advantageous because it means the bottom of each pocket is formed from the fold in the middle of the sheet and the sheet continues up the other side. This construction improves the strength and wearability of the pocket because if the attachment at the bottom of the pocket fails, the pocket is still usable because the sheet is held in that position by other attachment points. In a further embodiment of the invention, the bottom of the pockets is not attached and the fold in the sheet forms the bottom of the pockets. In a still further embodiment, a single sheet of material may be used that does not fold around the bottom edge (113) of the binder cover (102), but folds around the outer edges (127) and (125). In this embodiment, the pocket sheet could be specifically cut short and not extend under the sheet holding mechanism (291) but could terminate part of the way between the outer edges (125) or (127) and the respective hinge (117) or (115). In another embodiment, the material could terminate at hinges (117) and (115). In a still further embodiment, the material could be folded around the bottom edge (113) of the binder but have specific cutouts to prevent the sheet from being under the sheet holding mechanism (291) when in place. In yet another embodiment, the sheet could wrap around any edge of the binder cover (102) allowing a plurality of pockets to be formed as desired. Any construction method where a single sheet of material is used to construct all the pockets on both the inside and outside of a binder is called single sheet construction, regardless of how the pockets are actually formed. This type of construction allows for pockets to share uncut edges with other pockets which can improve their strength and resiliency.

In another embodiment of the invention, the pockets formed may be of different shapes or sizes than those shown. For instance, the pockets need not be bound at the attachment points (137) and (135). This could create a single large pocket wrapped around the lower portion of the binder cover (102) on the outside of the binder (101). This design allows for large papers to be placed securely in the pocket because of its increased dimensions. Further, because the pocket wraps around the spine, when the binder (101) is closed, the spine can push against the outer pocket at the hinges, forcing papers in the pocket in closer proximity to the covers (105) and (107) and/or spine (103). This can lead to increased holding power in the pocket when the binder (101) is closed, while simultaneously making it easier to store and remove papers in the pocket when the binder (101) is opened.

In another embodiment, the binder (101) has more than one pocket attached to it at any given attachment point so that there are more pockets on each cover. For instance, if single sheet construction was used with a first sheet of material folded around the bottom edge (113) of the binder cover (102) to form pockets as discussed above, a second single sheet could also be folded around the bottom edge (113) of the binder cover (102) simultaneously and attached to the same points as the first to double the number of pockets in every location. In another embodiment, different attachment points or different shaped sheets could be used for the additional pockets, possibly attaching one sheet to the prior one and not to the binder cover (102) at all.

In a still further embodiment, the pockets may be attached to the binder cover (102) at points other than those described above. This can allow for some or all of the pockets to be subdivided into smaller pockets, to have specially designed shapes for holding papers more securely, or to be larger and/or smaller than described.

FIG. 4 provides for a sheet (300) of material having two wavy edges (301) and (303) and two straight edges (325) and (327). Sheet (300) can be used to form the plurality of pockets (111), (121), (131), (141), (133), and (143) through single sheet construction. Sheet (300) can be manufactured by flat pattern die cutting, roller type die cutting, or any other method for cutting materials and can be manufactured of any material including, but not limited to, plastics, papers, cardboards, chipboards, metals, vinyls, or any combination of the above. Sheet (300) is designed to fold around the bottom edge (113) of the binder cover (102) by placement of the bottom edge along score line (313) and folding the sheet (300) around the binder cover (102). The wavy edge (301) therefore forms the top of the outer pockets, and the wavy edge (303) forms the top of the inner pockets (or vice versa). The straight edges (325) and (327) align with the outer edges (125) and (127) of the binder cover to form a flush outer edge. In the depicted embodiment, the straight edges (325) and (327) are score lines, designed for folding as sheet (300) has tabs (such as (337) and (335)) attached to the straight edges (325) and (327). These tabs can fold over the corresponding outer edge (127) or (125) of the binder cover (102) to provide a more secure outer edge of the pocket by providing the edge as a seam or fold in the material, instead of by just the attachment. Sheet (300) can also include additional structure to aid in the strength, manufacturing, and/or assembly of the product, particularly by high speed manufacturing machines. For instance, sheet (300) can include holes (393) and (394) which can correspond to the location of the rivet (109) to allow the rivet to pass through the material, and through the two spine pockets (133) and (143), in its progression through the binder cover (102) and into the rib (281). In another embodiment, the sheet can be at least partially attached after the rivet (109) has been placed so the rivet (109) does not impinge through the outer spine pocket's (133) storage space which would not require hole (393) (or (394) depending on how the sheet (300) was folded over the bottom edge (113) of the binder cover (102)). There are also two scored channels (317) and (315) included where the sheet can be attached to the hinges (117) and (115) and/or that are designed to interact with the hinges. In many binders, the hinges (117) and (115) are formed to have a noticeable width, therefore, in an embodiment, the channels (317) and (315) may be scored on both sides to correspond to that width to provide space for the hinges (117) and (115) to flex, and to provide for smoother bending of the hinges (117) and (115). Sheet (300) also includes two holes (313) and (323) around the score line (313) at the channels (317) and (315). These allow for less breakage of the sheet (300) when placed around the hinge at the bottom edge (113) of the binder cover (102). This point needs to be able to bend in multiple directions and elimination of material here can help prevent failure of the attachment and/or the pockets or cracking of the sheet (300).

The shape of the sheet (300) provides only one exemplary embodiment of sheets which may be used to form the pockets (111), (121), (131), (141), (133), and (143) on the binder cover (102). Sheet (300) can have a virtually limitless number of shapes and sizes. In addition, sheet (300) may have cut-outs, or holes for providing additional decorative patterns in the pockets or for reducing material use, improving manufacturing efficiency, or coping with strain at certain points. The score line (313) can also be off-centered to create different sized pockets on the inside compared to the outside.

In the embodiment depicted in FIG. 1 the binder cover (102) is shown made from a transparent or translucent material with the pockets made of a translucent material. This construction allows the pockets to be seen through the cover and through the opposing pocket providing a decorative look to the binder (101). In another embodiment, the binder cover (102) may be translucent or transparent while the pockets are opaque, which would provide a slightly different look to that of FIG. 1. In a still further embodiment, the binder cover could be opaque to eliminate the see-through pattern and/or the pockets could be transparent. In FIGS. 2 and 3, the binder cover (102) is opaque to provide improved visualization, but the position of the non-visible pockets (in dashed line) is still shown for reference. As is shown in FIG. 1, the interactions between the material of the pockets and the material of the cover produces an interesting design for the binder. At some points (such as on the front cover (105) toward the outer edge (125) and spaced from the bottom edge (113)) the inner pocket is visible through the binder cover (102) and appears as a first color (represented by the wide slashes). This first color is generated by light passing from the rear inner pocket (131), through the binder cover (102), and hitting the observer. At other points (such as toward the bottom edge (113)) the inner pocket and outer pocket (such as front inner pocket (111) and front outer pocket (121)) overlap producing a second color, generally darker than the first color (represented by the narrower slashes). This second color is generated by light passing from the front inner pocket (111), through the binder cover (102), through the front outer pocket (121) and hitting the observer. Still a third color is produced at yet other points(such as on the rear cover (107) toward the outer edge (127) and spaced from the bottom edge (113)) where there is no inner pocket but there is outer pocket. This third color is generated by light passing through the binder cover (102), through the front outer pocket (121) and hitting the observer. One of skill in the art would readily see that the first and third color would be the same if the binder cover (102) was transparent and the pockets were formed of materials with the same color (for instance because they were formed using single sheet construction such as was discussed in conjunction with FIG. 4). As this is the design of the embodiment shown in FIG. 1, this third color is represented by the same broad slashes as the first color. One of skill in the art would readily understand that a corresponding pattern of color would be visible if the binder (101) was viewed from the inside instead of from the outside.

In another embodiment, some or all the pockets and/or the binder cover (102) may be made from opaque material, this would allow the pockets on the non-observed side to be at least partially obscured by either the cover or the outside pockets. The cover may also be a translucent material which can make the three different color areas appear different depending on the placement of a light source. Further, careful selection of colors, transparency, translucency, diffraction, and/or reflection of the materials used (based on the interaction of light) for both the cover and the pockets could result in even more color combinations or interesting light effects all of which would be apparent to one of skill in the art. In a still further embodiment, individual pockets could contain multiple different materials for even more options for design.

FIGS. 1 through 4 also show the pockets having a wavy upper edge (151). This is desirable in an embodiment to create more interesting color patterns from the use of translucent and/or opaque materials as discussed above, however it is by no means necessary in other embodiments of the invention. In another embodiment, the pockets can be square, rectangular, or otherwise linear so as to provide more standard shapes for storage, or even to provide for linear patterns of light effects. The covers also could contain mixtures of different edges being curved at some points and linear at others. It is also clear from FIG. 1 that the pockets do not completely cover either the inside or outside of the binder, but extend only part way up the covers. As was discussed above, this allows for easier access to papers in the pockets. If transparent and translucent materials are used, it also allows more option for the decorative pattern to show through. In particular, the pattern on the front of the binder (101) may be different from the pattern on the back of the binder (101) even when the pockets are constructed from a single piece of material.

While the invention has been disclosed in connection with certain preferred embodiments, other embodiments should be understood to be encompassed in the present disclosure as would be understood by those of ordinary skill in the art.

1. A binder comprising:
A binder cover including a bottom edge, a top edge, an inside, and an outside;
A sheet holding mechanism attached to and inside said binder; and
A plurality of pockets, at least one pocket on the inside of said binder cover and one pocket on the outside of said binder cover, said plurality of pockets having tops spaced from said top edge of said binder cover, and bottoms flush with said bottom edge of said binder cover.

2. The binder of claim 1 wherein said tops of said pockets have a wavy edge.

3. The binder of claim 1 wherein said binder cover is made from at least one of, a translucent material, and a transparent material.

4. The binder of claim 1 wherein said pockets are made from at least one of, a translucent material, and a transparent material.

5. The binder of claim 1 wherein at least one of said binder cover and said pockets are made of an opaque material.

6. The binder of claim 1 wherein said pockets were formed from a single sheet of material.

7. The binder of claim 1 wherein at least one of said pockets on the inside of said binder cover shares an uncut edge with at least one pocket on the outside of said binder cover.

8. The binder of claim 1 wherein said sheet holding mechanism comprises a ring mechanism.

9. The binder of claim 1 wherein said binder comprises a three-ring binder

10. A binder comprising:
A binder cover including a bottom edge an inside and an outside, said binder cover being manufactured of at least one of a transparent material, and a translucent material;
A sheet holding mechanism attached to and inside said binder cover;
An inner pocket on the inside of said binder cover; and
An outer pocket on the outside of said binder cover;
Wherein said inner pocket is at least partially visible from the outside of said binder through said binder cover and said outer pocket is at least partially visible from the inside of said binder cover through said binder cover.

11. The binder of claim 10 wherein said inner pocket is at least partially visible from the outside of said binder through said outer pocket and said outer pocket is at least partially visible from the inside of said binder cover through said inner pocket.

12. The binder of claim 10 further comprising a second inner pocket and a second outer pocket, wherein said second inner pocket is at least partially visible from the outside of said binder through said binder cover and said second outer pocket is at least partially visible from the inside of said binder cover through said cover.

13. The binder of claim 12 wherein said second inner pocket is at least partially visible from the outside of said binder through said second outer pocket and said second outer pocket is at least partially visible from the inside of said binder cover through said second inner pocket.

14. The binder of claim 13 wherein all said pockets are formed from a single sheet of material.

15. The binder of claim 10 wherein all said pockets are formed from a single sheet of material.

16. The binder of claim 10 wherein said sheet holding mechanism comprises a ring mechanism.

17. The binder of claim 10 wherein said binder comprises a three-ring binder.

18. A method of constructing a binder with inside and outside pockets, the method comprising:
having a binder cover including a spine, a front cover and a back cover and having a bottom edge, a front outer edge, a back outer edge, a top edge, an inside, and an outside.
folding a sheet of material around at least one of said bottom edge, said front outer edge, and said back outer edge;
attaching said sheet of material to said binder cover at a plurality of locations to form at least one pocket between said sheet of material and said binder cover on said inside of said binder cover and at least one pocket between said sheet of material and said binder cover on said outside of said binder cover;
attaching a sheet holding mechanism inside said binder.

19. The method of claim 18 wherein said sheet is translucent.

20. The method of claim 18 wherein said binder cover is transparent.

21. The method of claim 18 wherein said binder cover is translucent.

22. The method of claim 18 wherein said sheet has two wavy edges.

23. The method of claim 18 wherein said at least one pocket on said inside of said binder cover is visible through said binder cover.

24. The method of claim 18 wherein said sheet holding mechanism comprises a ring mechanism.

25. The method of claim 18 wherein said binder is a three-ring binder.
